(19) United States
(12) Patent Application Publication
(10) Pub. No.: US 2007/0269619 A1
(43) Pub. Date: Nov. 22, 2007

(54) Ink-Jet Ink-Receptive Composition, Ink Composition Set for Ink-Jet Recording, and Ink-Jet Recording Method

(75) Inventors: Masahito Kato, Nagoya-shi (JP); Masahiro Nishizaki, Iwakura-shi (JP)

Correspondence Address: BANNER & WITCOFF, LTD.;ATTORNEYS FOR CLIENT NOS. 0166889, 006760, 1100 13th STREET, N.W., SUITE 1200, WASHINGTON, DC, 20005-4051, US

(73) Assignee: Brother Kogyo Kabushiki Kaisha, Nagoya-shi (JP)

(21) Appl. No.: 11/750,085

(22) Filed: May 17, 2007

(30) Foreign Application Priority Data
May 19, 2006 (JP) 2006-140405

(51) Int. Cl. B41M 5/50

(52) U.S. Cl. 428/32.34

(57) ABSTRACT

An ink-jet ink-receptive composition, which resolves problems such as blurring of images and show-through occurring when water soluble dye inks are employed on uncoated paper such as plain paper or ordinary postcards and which provide a high density and high quality image, contains a specific silica particle aggregate and polyvinylpyrrolidone.

### CROSS REFERENCE TO RELATED APPLICATION

This application claims the benefit of Japanese Patent Application No. 2006-140405, filed on May 19, 2006, which is incorporated herein by reference in its entirety.

### BACKGROUND

1. Field

One or more aspects of the present invention relates to an ink-jet ink-receptive composition, an ink composition set for ink-jet recording, and an ink-jet recording method.

2. Description of the Related Art

In an ink-jet recording method, when water soluble dye inks are used on recording materials such as plain paper, postcards or the like, the occurrence of phenomena such as blurring of recorded images, color bleeding and show-through (a status in which images recorded on recording material such as plane paper are seen through the backside of the recording material) must be suppressed in order to obtain high resolution recorded images. Conventionally, for this purpose, paper and postcards specially designed for ink-jet recording are employed. Specifically, in such dedicated paper and postcards, an ink-receptive layer is formed over the entire area of one surface thereof by means of an ordinary application method (for example, a screen printing method, a doctor blade coating method, or the like).

However, in the paper and postcards specially designed for ink-jet recording, the ink-receptive layer is not formed on demand but is formed over the entire area. Therefore, the ink-receptive layer is also formed on non-printed areas, and thus the ink-receptive layer of non-printed areas are not utilized. Furthermore, in an application method used for forming the ink-receptive layer, the thickness of the ink-receptive layer formed is necessarily in the order of several microns, which is larger than the thickness originally required for that purpose. Therefore, a problem exists in that the manufacturing cost per sheet is much higher than that of plain paper and ordinary postcards. Furthermore, each time the printing mode is switched between a normal quality printing mode and a high quality printing mode, plain paper or ordinary postcards in a paper tray of an ink-jet printer must be replaced with specially designed paper or postcards or vice versa. Therefore, a problem also exists in that printing takes time and effort.

Hence, a method has been proposed in which the ink-receptive layer itself is formed on a recording material in an on-demand manner. For example, a recording method has been proposed in Japanese Patent Application Laid-Open No. 2001-171095. Specifically, a translucent white ink composition is used which includes: a silica sol containing fine silica particles serving as an inorganic oxide pigment; polyvinyl alcohol serving as a polymer compound (binder); polyethylene glycol and N-methyl-2-pyrrolidone serving as water soluble organic solvents; and water. The translucent white ink composition is ejected from an ink-jet head onto a recording material and is made to adhere to printing areas to which color ink compositions for ink-jet recording are to be fixed, and ink receptive areas are formed in advance in an on-demand manner. Then, the color ink compositions for ink-jet recording are ejected onto these areas and are made to adhere thereto. According to this recording method, the minimum amount of necessary ink receptive areas can be formed on a recording material in an on-demand manner, and thus plain paper can be continuously used even when the printing mode is switched between a normal quality printing mode and a high quality printing mode.

However, in the technology of Japanese Patent Application Laid-Open No. 2001-171095 described above, sufficiently improved color effects are not obtained, and an improvement in color unevenness is also unsatisfactory. Therefore, further improvements in these characteristics are required.

### SUMMARY

One or more aspects of the present invention provides an ink-jet ink-receptive composition for forming an ink receptive area on a recording material in an on-demand manner. The ink-jet ink-receptive composition includes a silica particle aggregate and polyvinylpyrrolidone, wherein the silica particle aggregate is a least one of: an aggregate having a secondary structure portion in which primary particles of silica particles are bonded together in a long chain; and an aggregate having a structure in which primary particles of silica particles are bonded together through, and coated with, colloidal aluminum phosphate.

One or more aspects of the present invention provides an ink composition set for ink-jet recording, comprising the above detailed ink-jet ink-receptive composition and at least one ink composition for ink-jet recording.

One or more aspects of the present invention provides an ink-jet recording method for performing recording by ejecting the ink composition constituting the above detailed ink composition set from a nozzle of an ink-jet head to adhere the ink composition to a recording material. The ink-jet recording method includes: forming an ink-receptive area by ejecting the ink-jet ink-receptive composition constituting the ink composition set from the nozzle of the ink-jet head in an on-demand manner to adhere the ink-jet ink-receptive composition to the recording material; and ejecting the ink composition from the nozzle of the ink-jet head to adhere the ink composition to the ink-receptive area.

### DETAILED DESCRIPTION

The ink-jet ink-receptive composition of one or more aspects of the present invention is provided for forming ink-receptive areas on a recording material such as plain paper or ordinary postcards in an on-demand manner, and includes a silica particle aggregate and polyvinylpyrrolidone. As used herein, the ink-receptive areas being formed in an on-demand manner means that the right amount of the ink-jet ink-receptive composition is ejected from a nozzle of an ink-jet head and is made to adhere to regions (recording regions) on a recording material to which inks are to be made to adhere to form letters and images thereon.

In one or more aspects of the present invention, as the silica particle aggregate, one of the following types of aggregates is used in place of a simple aggregate of spherical silica particles: (1) an aggregate having a secondary structure portion in which the primary particles of the silica particles are bonded together in a long chain; and (2) an aggregate having a structure in which the primary particles of the silica particles are bonded together through, and coated with, colloidal aluminum phosphate. The use of such a specific silica particle aggregate increases the amount of interstices in ink-receptive areas on a recording material and also increases the surface area of the silica particle aggregate. Hence, the adsorption amount of a coloring agent on the ink-receptive areas increases, and an image with more vivid colors may be obtained. As the above “aggregate having a secondary structure portion in which the primary particles of the silica particles are bonded together in a long chain”, a silica sol disclosed in WO00/15552 may be used. Furthermore, as the above “aggregate having a structure in which the primary particles of the silica particles are bonded together through, and coated with, colloidal aluminum phosphate”, a complex sol disclosed in Japanese Patent Application Laid-Open No. 2004-2151 may be used.

In the aggregate having a secondary structure portion in which the primary particles of the silica particles are bonded together in a long chain, the term “secondary structure portion” refers to a portion having a pearl necklace shape structure. The silica particle aggregate itself may have a linear one-dimensional shape having one secondary structure portion as described above, a two-dimensional shape having a plurality of branched secondary structure portions, or a three-dimensional shape in which the secondary structure portions constitute cross-linking portions.

When the average diameter of the primary particles constituting the aggregate having the secondary structure portion in which the primary particles of the silica particles are bonded together in a long chain is too small, the interstices in the ink-receptive areas is insufficient. Therefore, the surface area of the silica particle aggregate decreases, and the amount of coloring agent adsorbed onto the ink-receptive areas decreases. Conversely, when the average diameter of the primary particles is too large, the interstices in the silica particle aggregate becomes too large, and thus the coloring agent is not satisfactorily held in the interstices. Therefore, the average diameter of the primary particles is in the range of about 10 nm to about 30 nm.

Furthermore, in the aggregate having the secondary structure portion in which the primary particles of the silica particles are bonded together in a long chain, when the length of the secondary structure portion is too short, the interstices in the ink-receptive areas is insufficient. Therefore, the surface area of the silica particle aggregate decreases, and the amount of coloring agent adsorbed onto the ink-receptive areas decreases. Conversely, when the length of the secondary structure portion is too long, the interstices in the silica particle aggregate becomes too large, and thus the coloring agent is not satisfactorily held in the interstices. Therefore, the length of the secondary structure portion may be in the range of about 3 times to about 20 times the average primary particle diameter of the silica particles, and the length of the aggregate may be in the range of about 70 nm to about 160 nm. As used herein, the length of the aggregate refers to the distance between the two farthest apart points which are spatially separated from each other in the aggregate.

In one or more aspects of the present invention, the silica particle aggregate having a structure in which the primary particles of the silica particles are bonded together through, and coated with, colloidal aluminum phosphate may be an aggregate having a linear one-dimensional shape such as a pearl necklace shape. Furthermore, this silica particle aggregate may be a two-dimensional-shaped aggregate having a branched structure formed from the one-dimensional-shaped aggregates or an aggregate having a three-dimensional shape having cross-linking portions formed from the one-dimensional-shaped aggregates.

When the average primary particle diameter of the silica particles constituting the aggregate having a structure in which the primary particles of the silica particles are bonded together through, and coated with, colloidal aluminum phosphate is too small, the interstices in the ink-receptive areas is insufficient. Therefore, the surface area of the silica particle aggregate decreases, and the amount of coloring agent adsorbed onto the ink-receptive areas decreases. Conversely, when the average primary particle diameter of the silica particles is too large, the interstices in the silica particle aggregate becomes too large, and thus the coloring agent is not satisfactorily held in the interstices. Therefore, the average primary particle diameter of the silica particles may be in the range of about 10 nm to about 100 nm.

Furthermore, in the aggregate having a structure in which the primary particles of the silica particles are bonded together through, and coated with, colloidal aluminum phosphate, when the length of the aggregate is too short, the interstices in the ink-receptive areas is insufficient. Therefore, the surface area of the silica particle aggregate decreases, and the amount of coloring agent adsorbed onto the ink-receptive areas decreases. Conversely, when the length of the aggregate is too long, the interstices in the silica particle aggregate becomes too large, and thus the coloring agent is not satisfactorily held in the interstices. Therefore, the length of the aggregate may be about three or more times the average primary particle diameter of the silica particles and may be in the range of about 150 nm to about 500 nm. As used herein, the length of the aggregate refers to the distance between the two farthest apart points which are spatially separated from each other in the aggregate. For example, when the aggregate is generally spherical, the diameter thereof is the length of the aggregate. Furthermore, when the aggregate has a planar ellipsoidal shape, the major axis thereof is taken as the size of the aggregate.

In the ink-jet ink-receptive composition of one or more aspects of the present invention, when the amount of the silica particle aggregate is too small, the ink-receptive areas formed from the silica particle aggregate are not formed to a sufficient thickness on a recording material, and thus blurring, show-through and the like are difficult to avoid. When the amount of the silica particle aggregate is too large, the dispersion state of the silica particle aggregate becomes unstable, and thus a problem arises in the long-term stability of the ink-jet ink-receptive composition. Therefore, the amount of the silica particle aggregate in the ink-jet ink-receptive composition may be in the range of about 3 wt. % to about 30 wt. %, and in the range of about 5 wt. % to about 15 wt. %.

In the ink-jet ink-receptive composition of one or more aspects of the present invention, polyvinylpyrrolidone is employed as a binder resin. The use of polyvinylpyrrolidone allows the silica particle aggregate to adhere uniformly to a recording medium, and thus a glossy, high quality image with no unevenness may be obtained.

In the ink-jet ink-receptive composition of one or more aspects of the present invention, when the amount of polyvinylpyrrolidone is too small, it is difficult to adhere the silica particle aggregate uniformly to a recording material. When the amount is too large, the viscosity of the ink-jet ink-receptive composition becomes too high, causing difficulty in stable ejection from an ink-jet head. Therefore, the amount of polyvinylpyrrolidone in the ink-jet ink-receptive composition may be in the range of about 0.5 wt. % to about 5 wt. %.

Furthermore, in the ink-jet ink-receptive composition of one or more aspects of the present invention, a binder resin other than polyvinylpyrrolidone (such as polyvinyl alcohol) may also be used within a range which does not impair the effects of one or more aspects of the present invention. It should be noted that, when a binder resin other than polyvinylpyrrolidone is also used, color unevenness tends to occur in the printed material obtained.

In the ink-jet ink-receptive composition of one or more aspects of the present invention, various solvents may be used as a vehicle. In particular, it is desirable that a water-based mixed solvent composed of water and a water soluble organic solvent be used.

The water may be deionized water. The amount of water in the ink-jet ink-receptive composition may be in the range of about 35 wt. % to about 85 wt. %.

The water soluble organic solvent include, but are not limited to: alcohols such as methyl alcohol, ethyl alcohol, n-propyl alcohol, isopropyl alcohol, n-butyl alcohol, sec-butyl alcohol and the like; amides such as dimethylformamide, dimethylacetamide and the like; ketones and keto-alcohols such as acetone, diacetone alcohol and the like; ethers such as tetrahydrofuran, dioxane and the like; polyalkylene glycols such as polyethylene glycol, polypropylene glycol and the like; alkylene glycols such as ethylene glycol, diethylene glycol, propylene glycol, triethylene glycol and the like; lower alkyl ethers of polyhydric alcohols such as glycerin, ethylene glycol methyl ether, ethylene glycol ethyl ether, diethylene glycol methyl ether, diethylene glycol ethyl ether and the like; di-lower alkyl ethers of polyhydric alcohols such as triethylene glycol dimethyl ether, triethylene glycol diethyl ether and the like; diols such as 1,3-propanediol, 1,4-butanediol and the like; sulfolane; N-methyl-2-pyrrolidone; 1,3-dimethyl-2-imidazolidinone; and the like. A combination of two or more types of the water soluble organic solvents may also be used.

In the ink-jet ink-receptive composition, the amount of the water soluble organic solvent may be in the range of 0 wt. % to about 50 wt. %.

The above detailed composition is the basic composition for the ink-jet ink-receptive composition of one or more aspects of the present invention. In addition to this, a well-known surfactant, surface tension modifier, mildewproofing agent, anticorrosive agent and the like may be added in accordance with need.

The above-described ink-jet ink-receptive composition of one or more aspects of the present invention may be combined with ink compositions for ink-jet recording, and the combination may be used as an ink composition set for ink-jet recording. This ink composition set is also a part of the present invention.

As the ink compositions for ink-jet recording constituting an ink composition set for ink-jet recording, color ink compositions generally used in an ink-jet recording method, such as yellow, magenta, cyan and black color ink compositions, may be used. So-called light ink compositions in which the above color ink compositions are diluted may also be used (the coloring agent concentration of the color ink compositions may be reduced). No particular limitation is imposed on the number of ink compositions for ink-jet recording constituting the ink composition set for ink-jet recording. Furthermore, the usable colors are not limited to the colors described above. No particular limitation is imposed on the coloring agent for each of the ink compositions for ink-jet recording. However, the coloring agent may be a dye in terms of the adsorption onto the silica particle aggregate.

No particular limitation is imposed on the vehicle used in each of the ink compositions for ink-jet recording. However, the same vehicle as that used in the ink-jet ink-receptive composition may be preferable in terms of the stability when the vehicles come into contact with each other.

In the ink-jet-receptive composition, a silica particle aggregate having a specific structure is used together with polyvinylpyrrolidone. This ink-jet ink-receptive composition is ejected from a nozzle of an ink-jet head and is made to adhere to a recording material in an on-demand manner before an ink composition for ink-jet recording is made to adhere thereto, and as such ink-receptive areas are formed on the recording material. When recording is performed by ejecting the ink composition onto the thus-formed ink-receptive areas to adhere the ink composition thereto, a coloring agent contained in the ink composition adhering to the ink-receptive areas is adsorbed onto the silica particle aggregate in the ink-receptive areas. Hence, the coloring agent is prevented from penetrating in a direction along the fibers of the recording material, and thus a high density and high quality image with no blurring and show-through may be obtained.

The ink composition set for ink-jet recording of one or more aspects of the present invention may be applied to an ink-jet recording method in which recording is performed by ejecting the ink compositions from nozzles of an ink-jet head to adhere the ink compositions to a recording material.

In this recording method, first, the ink-jet ink-receptive composition constituting the ink composition set is ejected from nozzles of an ink-jet head in an on-demand manner and is made to adhere to a recording material to form ink-receptive areas. An ink-jet head utilizing a known ink-jet driving method such as a piezo method, an electrostatic attraction method, a thermal method or the like may be used as the ink-jet head.

Next, the ink compositions are ejected from nozzles of the ink-jet head and are made to adhere to the ink-receptive areas previously formed. In this manner, recording is performed. The time interval between the adhesion of the ink-jet ink-receptive composition to the recording material (e.g., the formation of the ink-receptive areas) and the subsequent adhesion of a first ink composition for ink-jet recording to the ink-receptive area is determined such that the period of time for allowing the vehicle for the ink-jet ink-receptive composition to penetrate into the recording material may be ensured.

### EXAMPLES

### Method for Manufacturing Silica Particle Aggregates

(1) Manufacturing of a long-chained silica particle aggregate (an aggregate having a secondary structure portion in which the primary particles of the silica particles are bonded together in a long chain) Pure water was added to water glass No. 3 (the molar ratio of SiO₂ to Na₂O was 3.15, SiO₂ concentration of 29 wt. %), thereby obtaining an aqueous solution of sodium silicate (SiO₂ concentration of 3.6 wt. %). This aqueous solution of sodium silicate was allowed to pass through a cation-exchange resin column, thereby obtaining an active colloidal silica aqueous solution (SiO₂ concentration of 3.6 wt. %, pH of 3.0).

890 g of the above active colloidal silica aqueous solution was placed in a glass vessel, and 600 g of pure water was added thereto under stirring, thereby preparing an active colloidal silica aqueous solution (SiO₂ concentration of 2.2 wt. %, pH of 3.1). 60 g of a 10 wt. % aqueous solution of calcium nitrate was added to this aqueous solution under stirring, and the stirring was continued for 30 minutes. The thus-obtained mixture was used as a mixture A.

On the other hand, 2000 g of SNOWTEX® 0-40 (product of NISSAN CHEMICAL INDUSTRIES, LTD., an acidic spherical silica sol having an average particle diameter (a particle diameter measured by a nitrogen adsorption method) of 20.5 nm) was placed in another glass vessel. 6 g of 5 wt. % aqueous solution of sodium hydroxide was added to the SNOWTEX® 0-40 under stirring, and the stirring was continued for 30 minutes. The thus-obtained mixture was used as a mixture B.

Subsequently, the mixture B was added to the mixture A under stirring, and the stirring was continued for 30 minutes, thereby obtaining a mixture C. While the mixture C was stirred, 330 g of 2 wt. % aqueous solution of sodium hydroxide was added thereto for 10 minutes, and the stirring was continued for one hour. The thus-obtained mixture was charged into a stainless autoclave, and was heated at 135° C. for three hours under stirring. Then, the mixture was allowed to stand still and was cooled. In this manner, a mixture of the “long-chained silica particle aggregate” was obtained. According to the observation under an electron microscope, the silica particle aggregate had a secondary structure portion in which spherical silica particles were bonded together to form a long chain-like structure. The particle length of the silica particle aggregate was measured by means of a dynamic light scattering method and was found to be 120 nm.

### (2) Manufacturing of colloidal aluminum phosphate coated-bonded silica particles (an aggregate having a structure in which the primary particles of the silica particles are bonded together through, and coated with, colloidal aluminum phosphate)

In a 10 L glass vessel, 470 g of an alkaline silica sol having a specific surface area diameter (a particle diameter measured by a nitrogen adsorption method) of 22.1 nm (SNOWTEX® M30, product of NISSAN CHEMICAL INDUSTRIES, LTD., SiO₂ concentration of 35.0 wt. %, Na₂O concentration of 0.16 wt. %, the amount of SiO₂ was 164.5 g) and 3000 g of deionized water were placed. While the mixture was stirred at 1500 rpm with a disper-type stirrer, 19.3 g of 85% phosphoric acid aqueous solution (the amount of phosphoric acid was 16.4 g) was added thereto, and the stirring was continued for 20 minutes. Hence, a mixture E (pH of 1.9, SiO₂ concentration of 4.7 wt. %, phosphoric acid concentration of 0.47 wt. %) was obtained.

Subsequently, 1000 g of deionized water was added to 35.5 g of sodium aluminate aqueous solution (NA-150, product of Sumitomo Chemical Co., Ltd., Al₂O₃ concentration of 21.0 wt. %, Na₂O concentration of 19.0 wt. %, the molar ratio of Na to Al was 1.5, the amount of Al₂O₃was 7.5 g), thereby obtaining 1035.5 g of sodium aluminate aqueous solution (Al₂O₃ concentration of 0.72 wt. %).

While the above-described mixture E was stirred at 2500 rpm with a disper-type stirrer, 1035.5 g of the above sodium aluminate aqueous solution was continuously added thereto for 10 minutes, and the stirring was continued for 20 minutes. Subsequently, in order to adjust the pH of the mixture, 73 g of 10% sulfuric acid aqueous solution was continuously added to the mixture for 5 minutes under stirring, and the stirring was continued for 40 minutes. The thus-obtained mixture was used as a mixture F. The properties of the obtained mixture F were: the weigh ratio of silica to aluminum phosphate (SiO₂:AlPO₄) was 90.2:9.8; the concentration of colloidal silica was 3.56 wt. %; the concentration of aluminum phosphate (based on AlPO₄) was 0.39 wt. %; the total concentration of silica and aluminum phosphate was 3.95 wt. %; and the particle diameter measured by a dynamic light scattering method was 266 nm.

Next, while the mixture F was stirred at 1500 rpm, the mixture was aged under a temperature condition of 90° C. for two hours while care was taken that the mixture was not evaporated, and then the mixture was cooled. The weight of the complex sol obtained at this point was 4600 g. This sol was concentrated to about 1200 g using a flat membrane of an ultrafiltration membrane (Ultrafilter, product of Advantec Toyo Kaisha, Ltd., molecular weight cut off: 50000). About 1300 g of deionized water was added to the concentrated mixture and was further concentrated to 720 g, thereby obtaining a complex sol of “colloidal aluminum phosphate coated-bonded silica particles.” The obtained high-concentration complex sol had a SiO₂ concentration of 22.7 wt. %, an aluminum phosphate concentration (based on AlPO₄) of 2.5 wt. %, a total concentration of silica and aluminum phosphate of 25.2 wt. % and a particle diameter measured by a dynamic light scattering method of 240 nm. According to the observation under an electron microscope, the colloidal complex particles in the sol formed two- and three-dimensional aggregates. Furthermore, aluminum phosphate particles themselves were not observed, and thus it was found that the particles were evidently complexed.

### (3) Spherical Silica Particles and Alumina Particles

As spherical silica particles, SNOWTEX® 20 (product of NISSAN CHEMICAL INDUSTRIES, LTD.) was used. As aluminum particles, alumina sol 520 (product of NISSAN CHEMICAL INDUSTRIES, LTD.) was used.

### Example 1

### Preparation of an Ink-Jet Ink-Receptive Composition

With respect to the total weight of the ink-jet ink-receptive composition to be prepared, 35 wt. % of water (deionized water), 13 wt. % of glycerin and 1 wt. % of dipropylene glycol propyl ether were mixed, thereby preparing a mixture H. Subsequently, while the mixture H was stirred at 200 rpm, 1 wt. % of polyvinylpyrrolidone (trade name: Kollidon 17PF (product of BASF)) was added thereto, and the stirring was continued until the polyvinylpyrrolidone dissolved completely. The obtained mixture was used as a mixture I.

Next, in another vessel 50 wt. % of the long-chained silica particle aggregate mixture (the effective amount of silica particles was 21 wt. %) was placed, which was manufactured according to the above-described method for manufacturing the silica particle aggregate. While the dispersion of the silica particles was stirred at 200 rpm, the above-prepared mixture I was slowly added thereto. The stirring was continued for 30 minutes, and the dispersion was filtrated through a membrane filter having a pore diameter of 2.5 μm, thereby preparing the ink-jet ink-receptive composition of Example 1. The amount of the long-chained silica particle aggregate with respect to the total amount of the ink-jet ink-receptive composition was 10.5 wt. %.

### Examples 2 and 3 and Comparative Examples 1 to 7

Ink-jet ink-receptive compositions having compositions shown in Tables 1 and 2 were prepared by means of the same method as that in Example 1. The long-chained silica particle aggregate and the colloidal aluminum phosphate coated-bonded silica particles manufactured by the above method for manufacturing the silica particle aggregate were employed.

### Test Examples

### (Preparation of Print Samples)

Each of the ink-jet ink-receptive compositions of the Examples and Comparative Examples was filled in a predetermined cartridge, and the cartridge was attached to a digital multifunction device equipped with an ink-jet printer (MFC-5200J, product of Brother Industries, Ltd.) to prepare a print sample. Plain paper (DATA COPY paper, product of m-real) was used as a recording material.

The printing procedure was described below. According to the printing procedure, after the ink-jet ink-receptive composition was printed, an ink composition for ink-jet recording was printed thereon.

An ink cartridge in which one of the ink-jet ink-receptive compositions of Examples and Comparative Examples was filled and an ink cartridge in which a yellow ink composition for ink-jet recording normally used in the MFC-5200J was filled were attached to an ink cartridge attachment portion of the MFC-5200J. The printing was controlled by a driver such that, after the ink-jet ink-receptive composition was printed, the yellow ink composition was printed thereon, thereby printing a print sample by use of yellow color only. In this print sample, a pattern including appropriate amounts of solid printed portions, ruled lines, text and the like was printed. Similarly, print samples of cyan color only and magenta color only were printed.

### (Evaluation of Print Samples)

The evaluation of the print sample of each of Examples 1 to 3 and Comparative Examples 1 to 7 was performed according the following methods. The obtained results are shown in Tables 1 and 2.

### (Blurring Evaluation)

Blurring in the ruled lines of each of the print samples was evaluated by the following criteria. The blurring evaluation allowed to determine whether or not a high resolution and high quality image was obtained.

A: No blurring was found, and sharp ruled lines were obtained.

B: Blurring was slightly noticeable.

C: Blurring was obviously noticeable, and the outline of the ruled lines was jagged.

### (Show-Through Evaluation)

Observation was made on the back surface of each of the prepared print samples, and how the printing on the front surface was observed from the back was sensory evaluated. The show-through was evaluated by the following criteria.

A: The printing on the front surface was slightly observable.

B: Ink penetrating from the front surface was slightly observable.

C: Ink penetrating from the front surface was obviously observable on the back surface.

### (Color Unevenness Evaluation)

Observation was made on the solid printed portions on each of the prepared print samples, and whether or not color unevenness was observed in the solid printed portions was evaluated by the following criteria.

A: Fine solid printed portions with no color unevenness were obtained.

B: The color of a part of the solid printed portions was too light.

C: The entire part of the solid printed portions was too light or too dark.

### (Color Improvement Evaluation)

Each of the prepared print samples was evaluated for print density and chroma. The higher these measures, the higher the density and higher the chroma of the obtained printed material. The print density was evaluated by measuring the density by means of a reflection densitometer RD-914 (product of Gretag Macbeth). Furthermore, the chroma was evaluated by means of a spectrocolorimeter (MSC-P, product of Suga Test Instruments Co., Ltd., measurement conditions: light source: D₆₅, viewing angle: 2°).

The evaluation of print density and chroma was performed for each of the color inks, i.e., the yellow, magenta and cyan color inks. The evaluation was conducted to determine how much the print density and chroma were improved as compared to the case where the color ink composition was printed without using the ink-jet ink-receptive composition. The print density and chroma were evaluated by the following criteria.

AA: For each of the yellow, magenta and cyan colors, the print density was increased by 20% or more as compared to that of the reference sample, and the chroma was increased by 10% or more as compared to that of the reference sample.

A: For each of the yellow, magenta and cyan colors, the print density and chroma were increased by 10% or more as compared to those of the reference sample.

B: For any of the yellow, magenta and cyan colors, the print density or the chroma was not increased by 10% or more as compared to that of the reference sample.

C: The improvement in the print density and the chroma corresponding to the cases of AA, A and B were not observed.

TABLE 1

| | | | | | Comparative | Comparative |
|---|---|---|---|---|---|---|
| | | Example 1 | Example 2 | Example 3 | Example 1 | Example 2 |
| Particles | Name | Long-chained | Long-chained | Colloidal | Spherical | Alumina |
| used | | silica particle | silica particle | aluminum | silica | particles |
| | | aggregate | aggregate | phosphate | particles | (Alumina sol |
| | | | | coated-bonded | (SNOWTEX ® 20 *1) | 520 *2) |
| | | | | silica | | |
| | | | | particles | | |
| | Amount (effective | 10.5 | 10.5 | 10.5 | 10.5 | 10.5 |
| | amount) [wt. %] | | | | | |
| Binder | Name | Kollidon 17PF | Kollidon 25PF | Kollidon 17PF | Kollidon 17PF | Kollidon 17PF |
| resin | Name of material | Polyvinyl | Polyvinyl | Polyvinyl | Polyvinyl | Polyvinyl |
| | | pyrrolidone | pyrrolidone | pyrrolidone | pyrrolidone | pyrrolidone |
| | Manufacturer | BASF | BASF | BASF | BASF | BASF |
| | Amount [wt. %] | 1 | 1 | 1 | 1 | 1 |
| Other | Glycerin [wt. %] | 13 | 13 | 13 | 13 | 13 |
| components | Dipropylene glycol | 1 | 1 | 1 | 1 | 1 |
| | propyl ether [wt. %] | | | | | |
| | Deionized water | Balance | Balance | Balance | Balance | Balance |
| | [wt. %] | | | | | |
| Evaluation | Blurring | A | A | A | A | C |
| | Show-through | A | A | A | A | B |
| | Color unevenness | A | A | A | A | C |
| | Color improvement | AA | AA | AA | B | C |

*1, *2: Products of NISSAN CHEMICAL INDUSTRIES, LTD.

TABLE 2

| | | Comparative | Comparative | Comparative | Comparative | Comparative |
|---|---|---|---|---|---|---|
| | | Example 3 | Example 4 | Example 5 | Example 6 | Example 7 |
| Particles | Name | Spherical | Long-chained | Long-chained | Colloidal | Long-chained |
| used | | silica | silica particle | silica particle | aluminum | silica particle |
| | | particles | aggregate | aggregate | phosphate | aggregate |
| | | (SNOWTEX ® 20 *1) | | | coated-bonded | |
| | | | | | silica particles | |
| | Amount (effective | 10.5 | 10.5 | 10.5 | 10.5 | 10.5 |
| | amount) [wt. %] | | | | | |
| Binder | Name | PVA-205 | PVA-205 | PVA-405 | PVA-205 | — |
| resin | Name of material | Polyvinyl | Polyvinyl | Polyvinyl | Polyvinyl | — |
| | | alcohol | alcohol | alcohol | alcohol | |
| | Manufacturer | Kuraray | Kuraray | Kuraray | Kuraray | — |
| | Amount [wt. %] | 1 | 1 | 1 | 1 | — |
| Other | Glycerin [wt. %] | 13 | 13 | 13 | 13 | 13 |
| components | Dipropylene glycol | 1 | 1 | 1 | 1 | 1 |
| | propyl ether [wt. %] | | | | | |
| | Deionized water | Balance | Balance | Balance | Balance | Balance |
| | [wt. %] | | | | | |
| Evaluation | Blurring | A | A | A | A | A |
| | Show-through | A | A | A | A | A |
| | Color unevenness | C | C | C | C | C |
| | Color improvement | B | A | A | A | B |

*1: Product of NISSAN CHEMICAL INDUSTRIES, LTD.

As can be seen from Tables 1 and 2, each of Examples 1 to 3 is an example in which the ink-jet ink-receptive composition containing the specific silica particle aggregate and polyvinylpyrrolidone is employed. Thus, in each of Examples 1 to 3, a printed material excellent in terms of blurring, show-through, color unevenness and color improvement was obtained.

However, in Comparative Example 1, spherical silica particles were employed in place of the specific silica particle aggregates. Therefore, the color improvement was not satisfactory. Furthermore, in Comparative Example 2, alumina particles were employed in place of the specific silica particle aggregates. Therefore, blurring and color unevenness were observed in the printed material, and the color improvement was not satisfactory. In each of Comparative Examples 3 to 6, a binder different from polyvinylpyrrolidone was employed as the binder resin. Therefore, color unevenness was observed, and the quality of the printed material was slightly poorer than those in the Examples. In Comparative Example 7, a binder resin was not employed. Therefore, color unevenness was observed, and the degree of color improvement was not large. Thus, the quality of the obtained printed material was poorer than that of the Examples.

The invention is not limited to the embodiments described in the Examples, which are provided for illustrative purposes only. It will be apparent that various modifications can be made without departing from the spirit and the scope of the invention as described and claimed herein.

What is claimed is:

1. An ink-jet ink-receptive composition for forming an ink-receptive area on a recording material in an on-demand manner, comprising a silica particle aggregate and polyvinylpyrrolidone, wherein the silica particle aggregate is at least one of: an aggregate having a secondary structure portion in which primary particles of silica particles are bonded together in a long chain; and an aggregate having a structure in which primary particles of silica particles are bonded together through, and coated with, colloidal aluminum phosphate.

2. The ink-jet ink-receptive composition according to claim 1, wherein the silica particle aggregate is the aggregate having the secondary structure portion in which the primary particles of the silica particles are bonded together in a long chain, and wherein an average diameter of the primary particles of the silica particles is in the range of about 10 nm to about 30 nm.

3. The ink-jet ink-receptive composition according to claim 1, wherein a length of the secondary structure portion in which the primary particles of the silica particles are bonded together in a long chain is in the range of about 3 times to about 20 times the average primary particle diameter of the silica particles.

4. The ink-jet ink-receptive composition according to any of claim 1, wherein a length of the aggregate having the secondary structure portion in which the primary particles of the silica particles are bonded together in a long chain is in the range of about 70 nm to about 160 nm.

5. The ink-jet ink-receptive composition according to claim 1, wherein the silica particle aggregate is the aggregate having the structure in which the primary particles of the silica particles are bonded together through, and coated with, colloidal aluminum phosphate, and wherein an average diameter of the primary particles of the silica particles is in the range of about 10 nm to about 100 nm.

6. The ink-jet ink-receptive composition according to claim 5, wherein a diameter of the aggregate having the structure in which the primary particles of the silica particles are bonded together through, and coated with, colloidal aluminum phosphate is about three or more times the average size of the primary particle diameter of the silica particles, and is in the range of about 150 nm to about 500 nm.

7. An ink composition set for ink-jet recording, comprising the ink-jet ink-receptive composition according to claim 1 and at least one ink composition for ink-jet recording.

8. The ink composition set for ink-jet recording according to claim 7, wherein the ink composition comprises a dye as a coloring agent.

9. An ink-jet recording method for performing recording by ejecting the ink composition constituting the ink composition set according to claim 7 from a nozzle of an ink-jet head to adhere the ink composition to a recording material, the ink-jet recording method comprising:
forming an ink-receptive area by ejecting the ink- jet ink-receptive composition constituting the ink composition set from the nozzle of the ink-jet head in an on-demand manner to adhere the ink-jet ink-receptive composition to the recording material; and
ejecting the ink composition from the nozzle of the ink-jet head to adhere the ink composition to the ink-receptive area.
